(19) United States
(12) Patent Application Publication
(10) Pub. No.: US 2010/0243413 A1
(43) Pub. Date: Sep. 30, 2010

(54) TILT SWITCH

(75) Inventors: Ming-Cheng Chu, Tu-Cheng (TW); Guo-Lin Yang, Shenzhen City (CN); Fen Luo, Shenzhen City (CN); Cheng-Hao Chou, Tu-Cheng (TW); Te-Sheng Jan, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/546,706

(22) Filed: Aug. 25, 2009

(30) Foreign Application Priority Data
Mar. 24, 2009 (CN) 200910301076.7

(51) Int. Cl. H01H 35/02

(52) U.S. Cl. 200/61.52

(57) ABSTRACT

A simulated eye is provided. The tilt switch comprises an electrically insulating housing with a chamber formed therein. The chamber is defined by a bottom surface and a surrounding surface. The tilt switch also includes a plurality of contact terminals, each of which comprises an inner terminal portion and an outer terminal portion. Each inner terminal portion protrudes out of the surrounding surface of the chamber and extends in a direction substantially parallel to the bottom surface. The tilt switch further includes an electrically conductive moving member placed in a space defined by the cap, the bottom surface, and the plurality of contact terminals. The electrically conductive moving member is capable of simultaneously contacting with at most two of the plurality of contact terminals.

### RELATED APPLICATIONS

This application is related to U.S. patent application with an Attorney Docket Number of US23558 and a title of TILT SWITCH, which has the same assignee as the current application and has been concurrently filed.

### BACKGROUND

1. Technical Field

The present disclosure relates to tilt switches and, more particularly, to a tilt switch including a conductive movable member.

2. Description of Related Art

Referring to FIGS. 4 and 5, a tilt switch 10 is shown to include an insulating housing 11 with a chamber therein for rollably receiving an electrically conductive ball 12. Two pairs of first and second electric contact terminals 13 are press-fitted to a bottom plug 14, and have upper tip ends 131 extending into the chamber of the housing 11 when the plug 14 is secured to a bottom opening 111 of the housing 11 by virtue of engagement between protrusions 112 and recesses 142. Lower tip ends 132 of the terminals 13 are soldered to an electric contact member of a support (not shown). When the tilt switch 10 is mounted on the support, which stands on a horizontal plane 20, the ball 12 contacts the upper tip ends 131 to make an electrical connection between the first and second electric contact terminals 13. Once the support is tilted, the ball 12 will roll away from the terminals 13 to break the electrical connection.

The housing 11 has an inner peripheral wall surface 115 extending uprightly to confine the elongated accommodating chamber such that the ball 12 is rollable thereon. However, the ball 12 will not easily roll away from the terminals 13 unless the housing 11 is tilted down completely, and so the tilt switch 10 is not reliable.

Accordingly, there is a need to provide a tilt switch to solve the aforementioned problem.

### BRIEF DESCRIPTION OF THE DRAWINGS

FIG. 1 is an exploded, isometric view of a tilt switch in accordance with an exemplary embodiment.

FIG. 2 is another exploded, isometric view of the tilt switch of FIG. 1.

FIG. 3 is a top planar view of the tilt switch of FIG. 1.

FIG. 4 shows an exploded view of a related-art tilt switch.

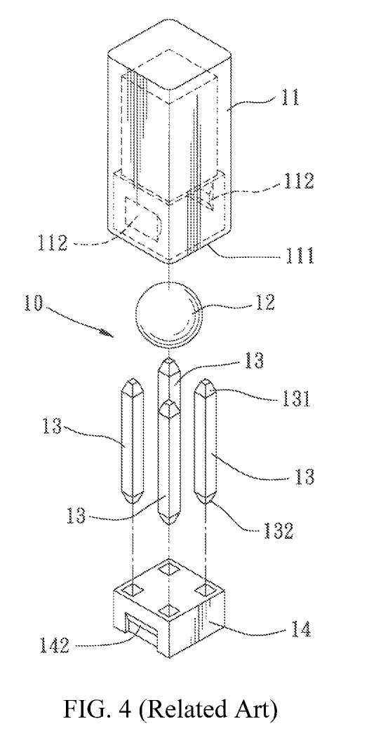

FIG. 5 is a cross-sectional view of the related-art tilt switch of FIG. 4.

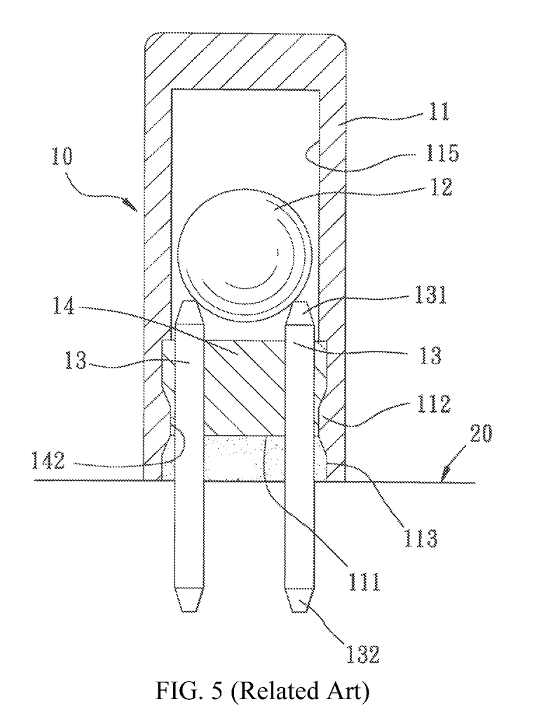

### DETAILED DESCRIPTION

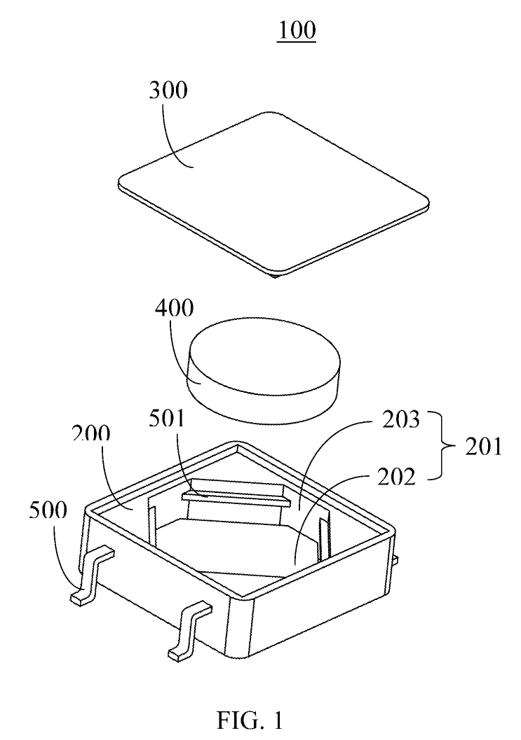

FIG. 1 shows a tilt switch 100 in accordance with an exemplary embodiment. The tilt switch 100 includes a housing 200, a cap 300, a conductive movable member 400, and a plurality of contact terminals 500.

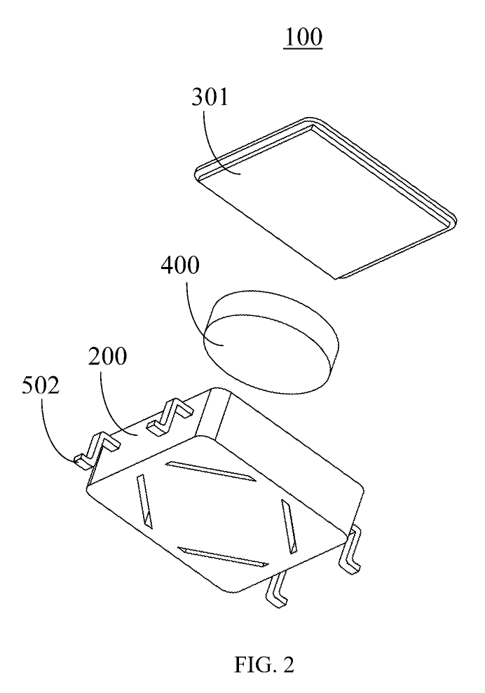

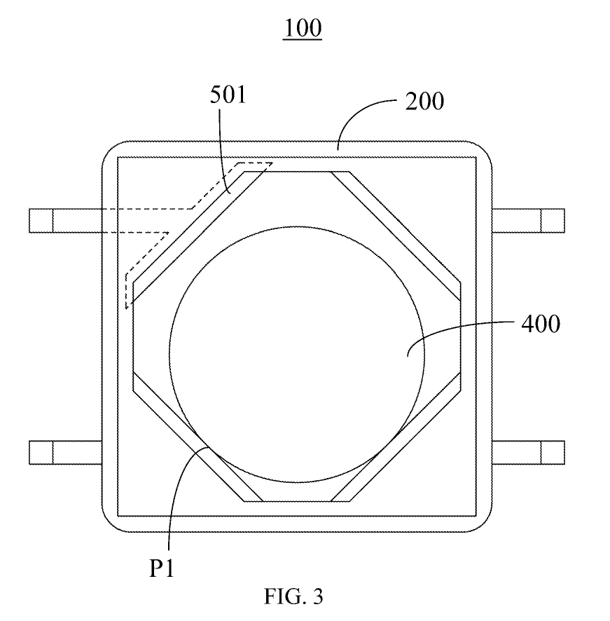

Referring to FIGS. 2 and 3, the housing 200 is made of electrically insulating material. In the exemplary embodiment, the housing 200 is made of plastic material. A chamber 201 is formed in the housing 200 and is defined by a bottom surface 202 and a surrounding wall 203. The cap 300 is attached above the chamber 201 and includes a bottom surface 301 that is opposite to the bottom surface 202. The cap 300 is shaped to fit the opening of the chamber 201 and is used to cover the chamber 201.

In the exemplary embodiment, there are four contact terminals 500. The four contact terminals 500 are formed integrally with the housing 200. The contact terminals 500 can be made of magnetic material. Each contact terminal 500 includes an inner terminal portion 501 and an outer terminal portion 502. The inner terminal portion 501 is positioned within the chamber 201 and the outer terminal portion 502 protrudes outwardly from the outside surface of the housing 200. The outer terminal portions 502 can be soldered to a PCB contained within a device (not shown) utilizing the tilt switch 100.

In the exemplary embodiment, the inner terminal portion 501 and the outer terminal portion 502 are integrally formed with each other. The inner terminal portions 502 are positioned in such a way that the movable member 400 is capable of simultaneously contacting at most two of the contact terminals 500.

In the exemplary embodiment, the inner terminal portion 501 protrudes out of the surrounding wall 203 and extends in a direction substantially parallel to the bottom surface 202. With such configuration, it is possible to construct the housing 200 in such a way that the space provided in the height direction of the housing 200 is a little greater than the height of the inner terminal portion 501. Therefore, the need for much space in the height direction of the housing 200 is eliminated and it is possible to construct a slim tilt switch 100. In the exemplary embodiment, the inner terminal portion 501 includes a side surface 503 that is substantially perpendicular to the bottom surface 202.

The movable member 400 is movably placed within the chamber 201. In the exemplary embodiment, the movable member 400 has a flat cylindrical shape. The movable member 400 is made of magnetic material. The movable member 400 is shaped to have a height slightly smaller than the depth of the chamber 201, such that the movable member 400 can hardly flip over in the housing 200. The height of the movable member 400 is also greater than that of the inner terminal portions 501. The movable 400 is shaped to fit the chamber 201, which allows a free movement along the bottom surface 202 of the housing 200.

When incorporated in a device (not shown), the tilt switch 100 is mounted vertically, with the bottom surface 202 of the chamber 201 generally perpendicular to the ground. With the tilt switch 100 in such an initial position as shown in FIG. 3, the movable member 400 is supported by two lower contact terminals 500, thereby forming an electrical connection between the contact terminals 500.

The movable member 400 stays in contact with the two contact terminals 500 until the housing 200 is tilted leftwards or rightwards from the initial position to at least a predetermined angle. For example, in the process of tilting the housing 200 leftwards, a gravitational torque about a support point P1 of the contact terminal 500 acts on the movable member 400. The gravitational torque continues decreasing until the housing 200 is tilted to the predetermined angle and becomes zero when the gravity of the movable member 400 acts through the support point P1. In the present embodiment, the predetermined angle is about 45 degrees.

Before the housing 200 tilts to the predetermined angle, the gravitational torque prevents the movable member 400 from rolling around the support point P1. As the housing 200 has tilted to the predetermined angle and continues tilting, the gravitational torque continues increasing. When the gravitational torque has increased to predetermined value, the magnetic force between the moving member 400 and the pair of inner terminal portions 502 supporting the moving member 400 is overcome and the moving member 400 moves until being supported by another pair of contact terminals 500. Because the existence of the magnetic force, the moving member 400 does not move until the magnetic force has been overcome, unintentional movement of the moving member 400 can be reduced to a minimal degree.

The tilt switch 100 can be used in an upright standing appliance, such as a light stand, fan, heater, etc. In an exemplary embodiment, two tilt switches 100 are used in an upright standing appliance, one for detecting leftward and rightward tilt, and the other for detecting forward and backward tilt. By detecting electrical connection of another pair of contact terminals 500, the upright standing appliance determines if it has leaned and can thus cut off power for safety purposes.

While one embodiment has been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A tilt switch comprising:
an electrically insulating housing with a chamber formed therein, wherein the chamber is defined by a bottom surface and a surrounding surface;
a cap attached above the chamber;
a plurality of contact terminals, each of the plurality of contact terminals comprising an outer terminal portion and an inner terminal portion, the inner terminal portions being positioned within the chamber and spaced from each other, wherein the plurality of contact terminals are made of magnetic material;
an electrically-conductive magnetic moving member placed in a space defined by the cap, the bottom surface, and the plurality of contact terminals, wherein the electrically-conductive magnetic moving member is capable of simultaneously contacting with at most two of the inner terminal portions.

2. The tilt switch according to claim 1, wherein the number of the plurality of contact terminals is four.

3. The tilt switch according to claim 1, wherein the inner terminal and the outer terminal portion are integral with each other.

4. The tilt switch according to claim 1, wherein the plurality of contact terminals are formed integrally with the electrically insulating housing.

5. The tilt switch according to claim 4, wherein the insulating housing is made of plastic material.

6. The tilt switch according to claim 1, wherein the moving member has a shape of flat cylinder.

7. The tilt switch according to claim 6, wherein each inner terminal portion includes a side surface that is perpendicular to the bottom surface of the chamber.

8. The tilt switch according to claim 7, wherein the height of the flat cylinder is greater than that of the inner terminal portion.

9. The tilt switch according to claim 2, wherein the electrically conductive moving member is configured for simultaneously contacting with two of the contact terminals.
